(19) United States
(12) Patent Application Publication
(10) Pub. No.: US 2009/0150329 A1
(43) Pub. Date: Jun. 11, 2009

(54) SYSTEMS AND METHODS FOR ENHANCING PROVIDER EFFICIENCY AND COMMUNICATION

(75) Inventors: Arien Malec, Oakland, CA (US); Aron Ralston, Alameda, CA (US); Andrea Sim, San Francisco, CA (US); Richard Wang, Saratoga, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 11/951,032

(22) Filed: Dec. 5, 2007

(51) Int. Cl. G06F 17/30

(52) U.S. Cl. 707/1; 707/E17.005

(57) ABSTRACT

A system, method, and computer program product are provided for mapping information to message templates and transmitting messages to and from providers reporting results, guiding providers through workflows, communicating tasks that require action to third-parties, and managing and performing tasks in high-volume.

### FIELD OF THE INVENTION

In general, exemplary embodiments of the present invention relate to systems and methods for enhancing efficiency and communication among service providers and customers.

### BACKGROUND OF THE INVENTION

In the healthcare industry, systems that connect providers, patients, insurers, payors, and pharmacies are being developed at increasing rates. As the development of such systems continues, the functionality available to the users will be enhanced. The enhancements will alleviate many of the burdens of performing manual tasks that can be performed more effectively and efficiently with the aid of technology.

For instance, to communicate laboratory results to patients or others, providers typically mail letters with interpreted laboratory results, mail the laboratory results without interpreting them, or place telephone calls to report the laboratory results. Mailing the interpreted laboratory results or calling the parties can be both time consuming and prone to errors. And although mailing the actual laboratory results to patients may be quicker, it often creates patient confusion resulting in additional work for the provider.

In the same way, providers, such as pharmacists, often have workflows that health care plan providers, hospitals, and others request that the pharmacists perform. For instance, pharmacists often must check for the availability of generic prescriptions for each prescribed medication in accordance with a health care plan provider's request. Pharmacists also check for potential drug-to-drug interactions and allergic reactions that could be harmful to the patient. When potential issues like these arise, pharmacists and other providers typically place phone calls and wait in call queues to speak with the prescribing doctor to change the medication. Too often, the pharmacists wait on hold only to learn that they will receive a return phone call or must call back themselves. In addition to frustrating the pharmacist, this method of dealing with potential patient issues is inefficient and does not provide for adequate follow up for the pharmacists and providers.

Similarly, processing common tasks in high-volume can require significant provider resources if performed manually. For example, providers typically process a high number of prescription renewals for their patients. Currently, providers call or send faxes to the pharmacies to confirm prescription changes or renewals. This may result in waiting in a telephone queue to speak with a pharmacist or require typing, printing, and faxing instructions. The manual methods of performing these tasks are time consuming and error-prone ways for providers to perform common, high-volume tasks.

Thus, a need exists to provide for a more efficient way to transmit messages to and from providers reporting results, guide providers through workflows, communicate tasks that require action by third-parties, and manage and perform tasks in high-volume.

### BRIEF SUMMARY OF THE INVENTION

In general, exemplary embodiments of the present invention provide methods and systems for transmitting messages to and from providers reporting results, guiding providers through workflows, communicating tasks that require action to third-parties, and managing and performing tasks in high-volume.

In accordance with one embodiment, a method is provided for receiving results data, wherein the results data may include a procedure code and procedure results information. The results data containing the procedure code can then be mapped to one or more result templates. In this embodiment, one or more result templates can be displayed to a user to select one or more the result templates for use. After the appropriate result templates are selected, the method can include mapping the procedure results information to statement parts in the result template. This can then be used to generate a message reporting the results data.

In another embodiment, a system is provided in which the processor is configured to receive results data that may include a procedure code and procedure results information. The processor can be further configured to map the procedure code from the results data to at least one result template and cause the result templates to be displayed. The processor can also receive a selection selecting at least one of the result templates for use and map the procedure results information to statement parts of the result template. This can then be used to generate a message reporting the results data.

In another aspect of the invention, a method is provided for receiving customer information from a requesting party. The received customer information is used to determine if an intervention should be executed. In this embodiment, the intervention can be identified by an intervention ID. If an intervention should be executed the method provides for execution. After executing the intervention, the method provides for receiving a notification from the requesting party that at least one task needs to be performed by a third party. The method also includes notifying the third party of the task that needs to be completed.

In yet another embodiment, a system is provided in which the processor is configured to receive customer information from a requesting party and determine if the received information indicates that an intervention should be executed. If an intervention should be executed, the processor executes the intervention. The processor is also configured to receive a notification from the requesting party that at least one task needs to be performed by a third party. In response, the processor can be configured to transmit the task to be performed to the third party.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1 and 2 show embodiments of an exemplary Distribution Service System.

FIG. 3 shows exemplary steps of one embodiment of a template module.

FIGS. 4-7 show exemplary output produced by one embodiment of the template module.

FIGS. 8-9 show exemplary data that can be used by one embodiment of the template module.

FIGS. 10-13 show exemplary output produced by one embodiment of the template module.

FIGS. 14-15 show exemplary steps of one embodiment of a workflow module.

FIGS. 16-32 show exemplary input and output produced by one embodiment of the workflow module.

FIGS. 33-39 show exemplary input and output produced by one embodiment of a volume processing module.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As should be appreciated, the exemplary embodiments may be implemented as methods, apparatus, network entities, systems, or computer program products. Accordingly, the exemplary embodiments may take the form of an entirely hardware embodiment, an entirely software embodiment, or an embodiment combining software and hardware aspects. Furthermore, the various implementations may take the form of a computer program product on a computer-readable storage medium having computer-readable program instructions (e.g., computer software) embodied in the storage medium. More particularly, implementations of the exemplary embodiments may take the form of web-implemented computer software. Any suitable computer-readable storage medium may be utilized including hard disks, CD-ROMs, optical storage devices, or magnetic storage devices.

The exemplary embodiments are described below with reference to block diagrams and flowchart illustrations of methods, apparatus, network entities, systems, and computer program products. It should be understood that each block of the block diagrams and flowchart illustrations, respectively, can be implemented by computer program instructions, e.g., as logical steps. These computer program instructions may be loaded onto a general purpose computer, special purpose computer, or other programmable data processing apparatus to produce a machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support various combinations for performing the specified functions, combinations of steps for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### Overall System

The Distribution Service System (“DSS”) 100 is a secure online connectivity solution that connects providers, patients, insurers, payors, and pharmacies. The DSS 100 can provide secure access to information in real-time. For example, the DSS 100 can provide the functionality that allows patients to access up-to-date account information, the ability to pay their bills online, and the ability to receive lab results via email. Providers can use DSS 100 to provide results to patients via email or fax, such as the results of a cholesterol panel. It can also be used to help providers process prescription renewals with pharmacies and/or guide providers through workflows while providing messaging, follow up, and billing functionality for each party. In short, a system such as DSS 100 has virtually endless functionality. The various embodiments of the DSS 100 could be implemented on a variety of platforms.

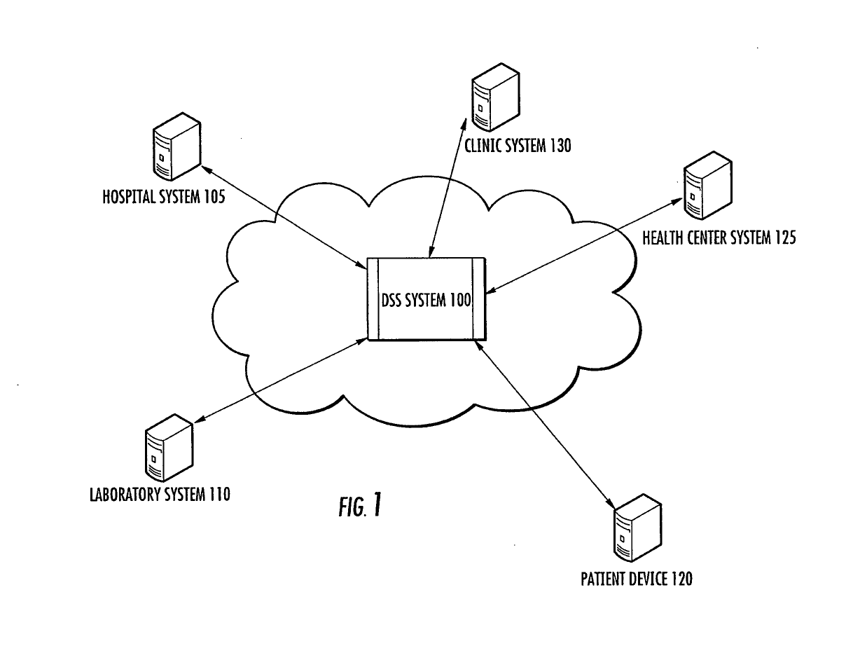

FIG. 1 shows an DSS 100 according to an exemplary embodiment. The phrases “Distribution Service System” and “DSS” are used generically to refer to any computer, mainframe, desktop, notebook or laptop, distributed system, gateway, router, server, hub, switch, repeater, or any other processing device configured to perform the functions described herein. As will be understood from FIG. 1, in this embodiment, the DSS 100 is connected to one or more networks (e.g., connected via a local area network (LAN), metropolitan area network (MAN), wide area network (WAN), the Internet, or private network) to communicate with other computing entities, such as a hospital system 105, a laboratory information system 110, and/or a patient device 120. Although a single hospital system, a single laboratory information system and a single patient device are shown in FIG. 1, the DSS may be connected to a plurality of any one or all of these systems/devices. This communication is typically executed using a wired data transmission protocol, such as X.25, ISDN, DSL, PIP, Ethernet, ATM, frame relay, DOCSIS, or any other wired transmission protocol. Similarly, the DSS 100 may be configured to communicate via wireless external communication networks using any of a variety of protocols. Also, the DSS 100 may be embodied in a distributed computing system in which the various functions may be implemented through separate systems. The separate systems could be located locally or remotely from one another.

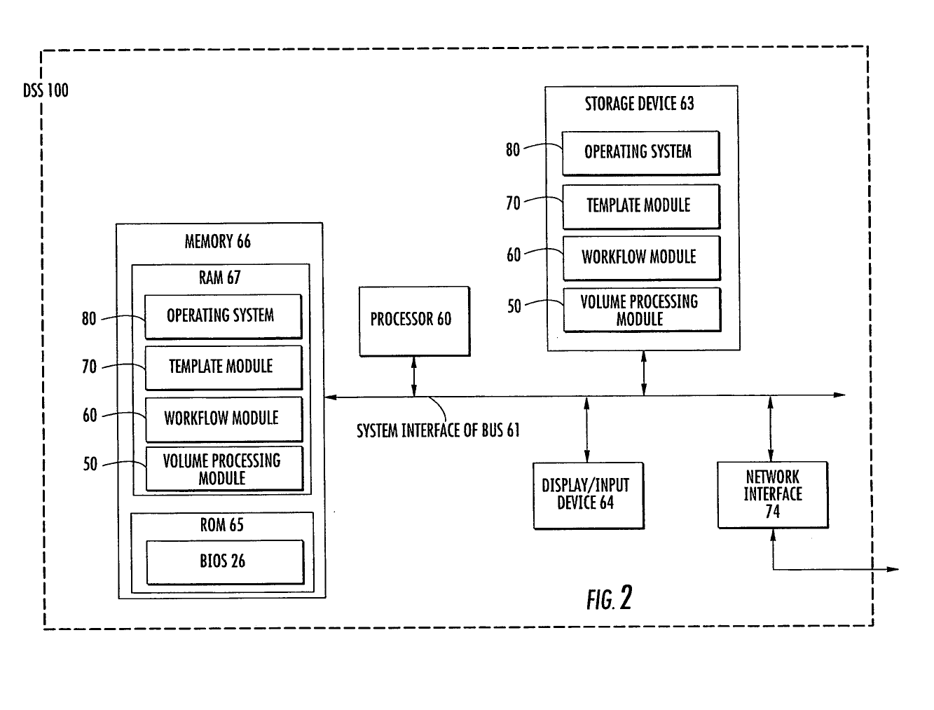

Alternatively, in another embodiment shown in FIG. 2, some of DSS' 100 functionality may be implemented via modules, such as a volume processing module 50, a workflow module 60, and a template module 70. As will be recognized, though, the architectures described are exemplary and not limiting to the various embodiments.

As mentioned, FIG. 2 shows one embodiment of DSS 100 implementing the functionality described herein as modules. As will be understood from this figure, in this embodiment, DSS 100 includes a processor 60 that communicates with other elements within the DSS 100 via a system interface or bus 61. The DSS 100 also includes a display/input device 64 for receiving and displaying data. This display/input device 64 may be, for example, a keyboard or pointing device used in combination with a monitor. The DSS 100 further includes memory 66, which may include both read only memory (ROM) 65 and random access memory (RAM) 67. The DSS' ROM 65 is used to store a basic input/output system 26 (BIOS), containing the basic routines that help to transfer information between elements within the geographical mapping system 370.

In addition, the DSS 100 may include a storage device 63, such as a hard disk drive, a floppy disk drive, a CD ROM drive, or an optical disk drive, for storing information on various computer-readable media, such as a hard disk, a removable magnetic disk, or a CD-ROM disk. As will be appreciated, each of these storage devices 63 may be connected to the system bus 61 by an appropriate interface. The storage devices 63 and their associated computer-readable media provide nonvolatile storage. The computer-readable media described above could be replaced by any other type of computer-readable media, e.g., magnetic cassettes, flash memory cards, digital video disks, and Bernoulli cartridges.

A number of program modules may be stored by the various storage devices and within RAM 67. Such program modules may include a volume processing module 50, a workflow module 60, a template module 70, and an operating system 80. The volume processing module 50, the workflow module 60, and the template module 70 control certain aspects of the operation of the DSS 100, with the assistance of the processor 60 and operating system 80.

Also located within the DSS 100 is a network interface 74 for interfacing and communicating with other elements of a computer network. It will be appreciated that one or more of the DSS 100 components may be located remotely from other DSS 100 components. Furthermore, one or more of the components may be combined, and additional components performing functions described herein may be included in the DSS 100. In this regard, although various program modules are described, the software need not be modularized. Some of the functionality of the DSS 100 is described in the following sections.

### Template Module

The template module 70 can be used to communicate messages to and/or from providers, patients, insurers, payors, pharmacies, and/or any party desired. The template module 70 can populate or map (the terms populate and map are used interchangeably) information to a template that can be used to generate a message. In one embodiment, the template module 70 can be used to communicate messages such as laboratory results to patients. It should be understood, though, that the template module 70 can be used to map information that can be used to generate any kind of message.

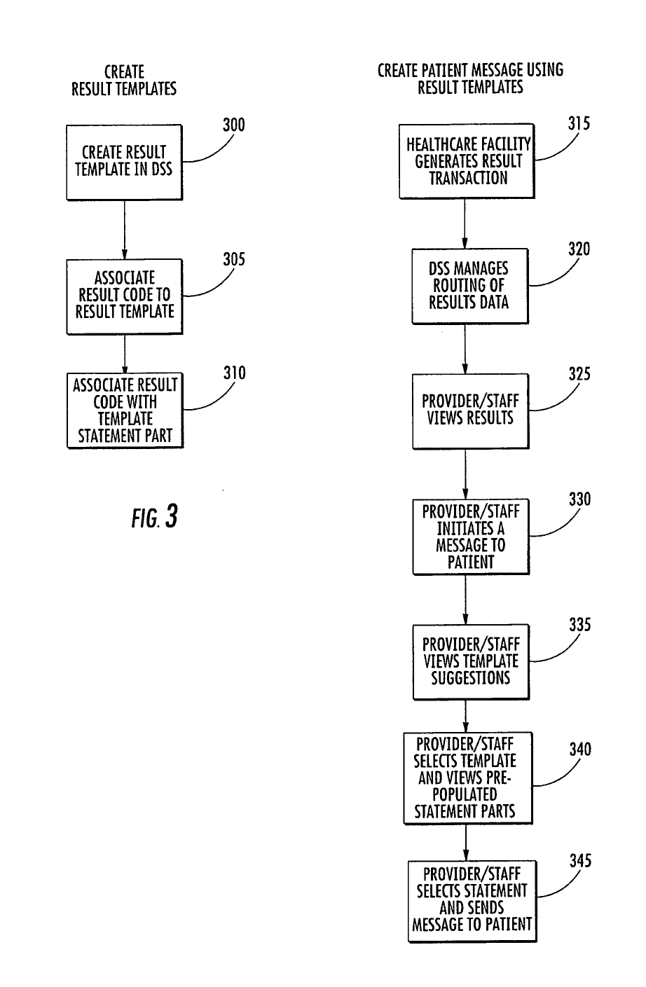

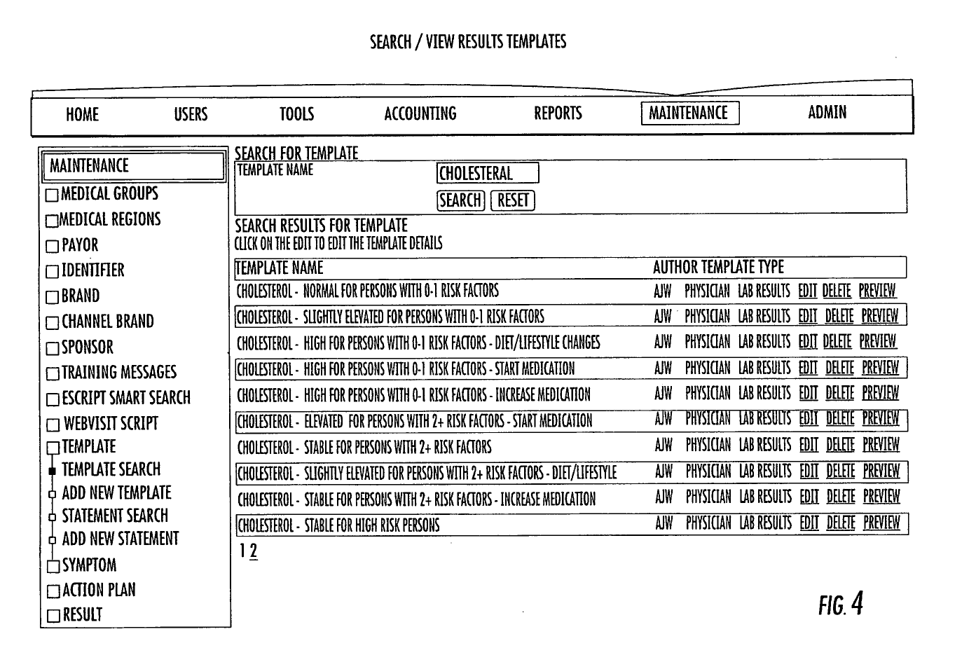

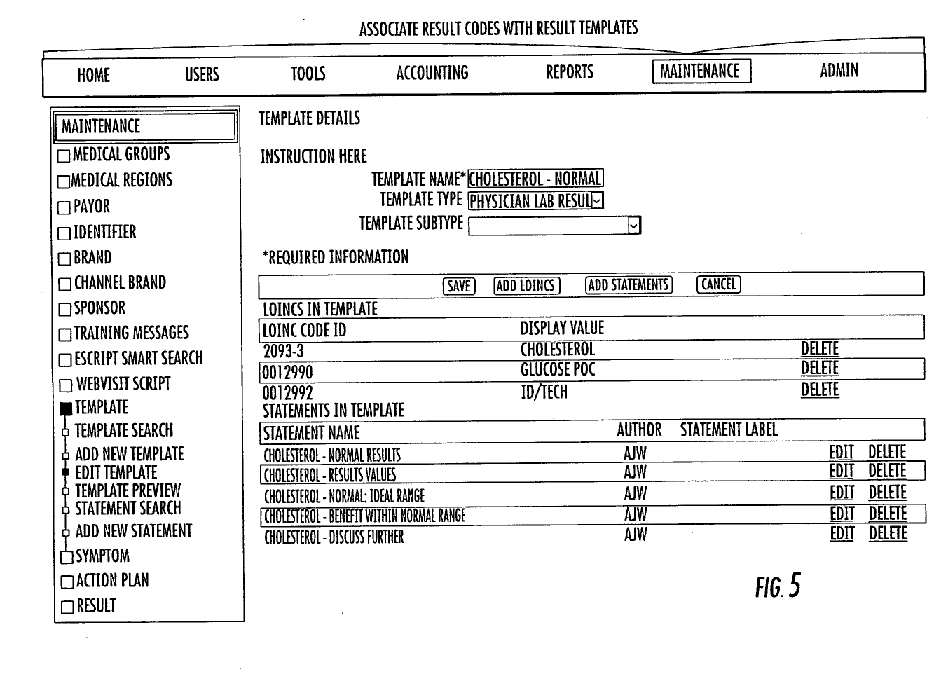

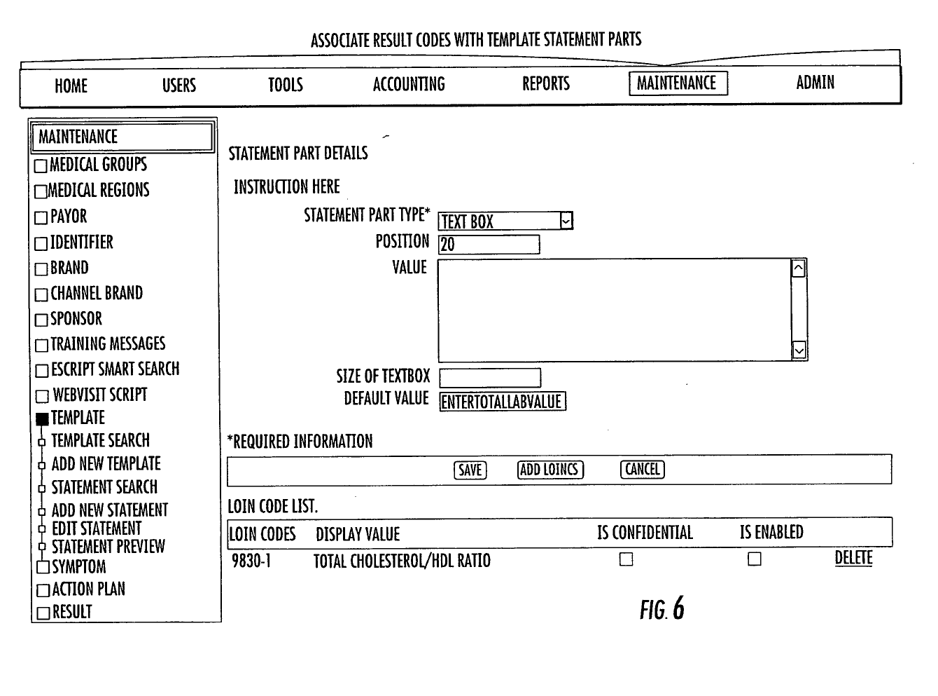

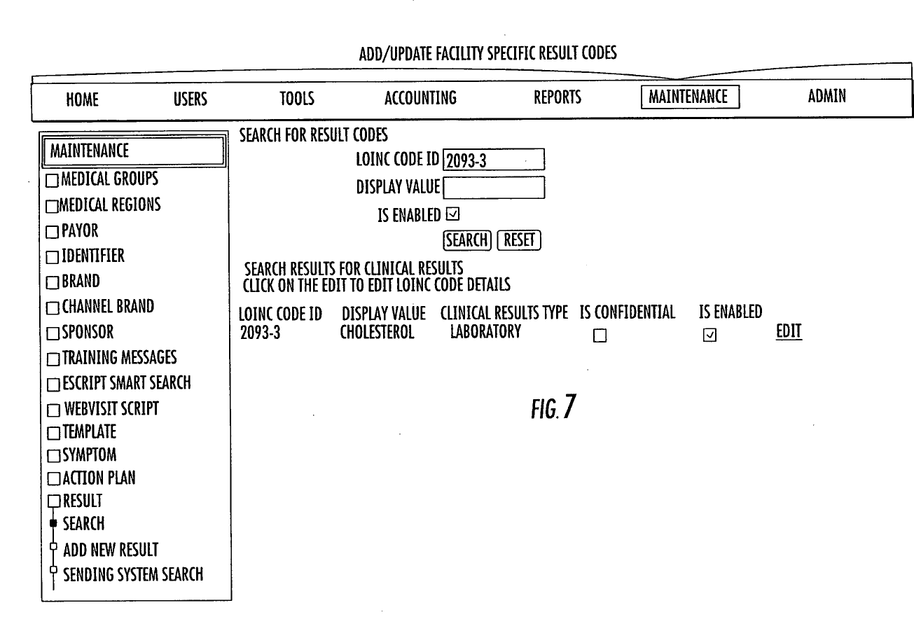

As indicated in FIG. 3, the DSS 100 can be used to store and/or create result templates. To create a result template, the author typically creates a template name and a template type. Each result template usually includes one or more codes relating to, for instance, specific laboratory or medical procedures (as shown in FIG. 5 and Step 300). In this regard, a particular template type may be predefined to include certain associated codes. Alternatively, an author of a result template may define the codes to be associated with the respective result template. In one embodiment, the template module 70 uses the healthcare industry standard logical observation identifiers, names, and codes (“LOINC” codes) to define the result templates. The various codes can be associated with one or more result templates (Step 305). Thus, as seen in FIG. 4, a cholesterol panel might have several templates associated with the procedure or code. Alternatively, a single code could be associated with only a single result template. Thus, depending on the procedure performed or the code used, several different templates could be used to create a message.

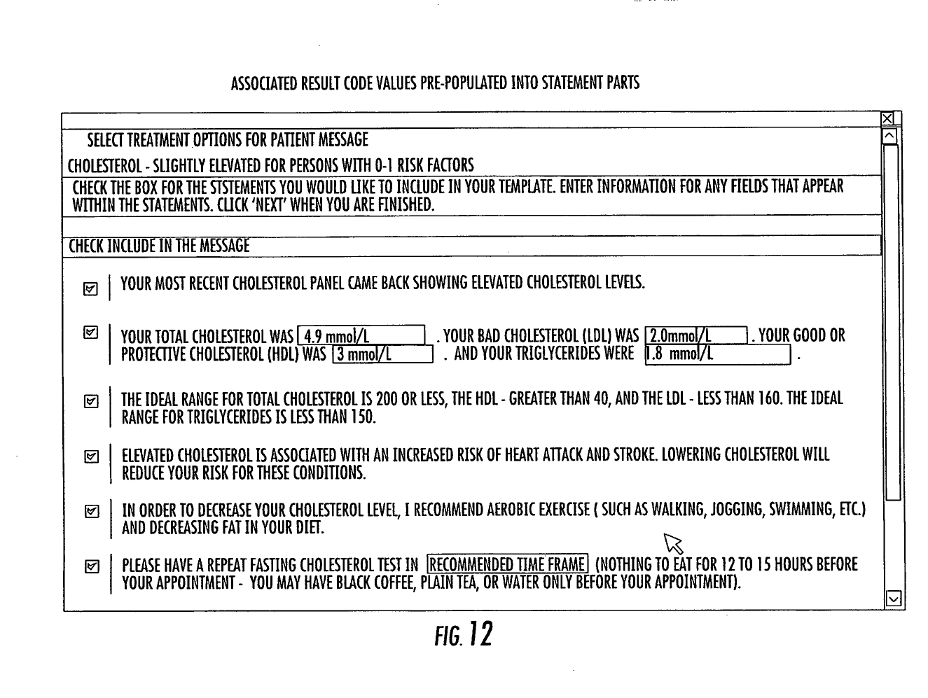

The final step in creating a result template, in this embodiment, is to associate the range of results relating to the procedure or code with a statement part(s) (Step 310). A statement part is typically a statement(s) related to a range of results for a specific procedure. Exemplary statement parts are shown in FIG. 12. In one embodiment, the statement part is a patient-friendly sentence(s) that explains the laboratory results to the patient. Thus, the statement parts may be predefined, such as provided by a library of potential statement parts, and an author of a result template may select from the available statement parts those particular statement parts that are appropriate for the respective result template. Additionally, or alternatively, an author of the result template may draft one or more statement parts to be included within the result template. Regardless of its origin, as shown in FIG. 12, the statement parts can include fields that are automatically populated by the result of or other information associated with a procedure that has been performed. After the result templates have been created and stored, they are ready for use.

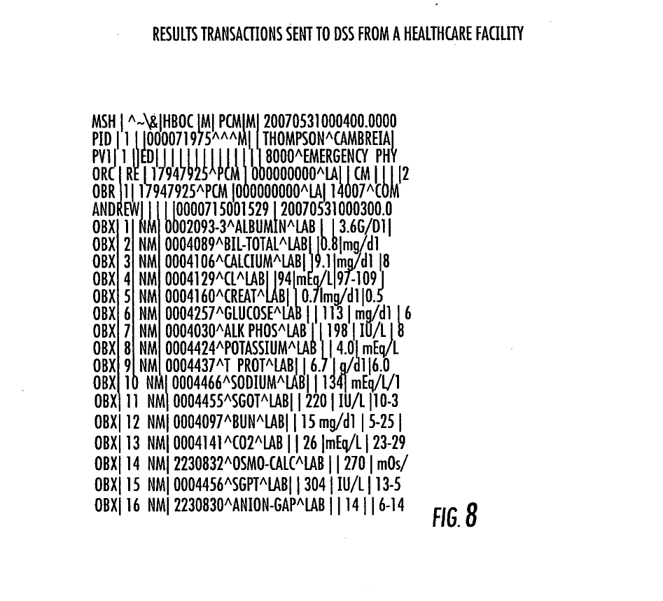

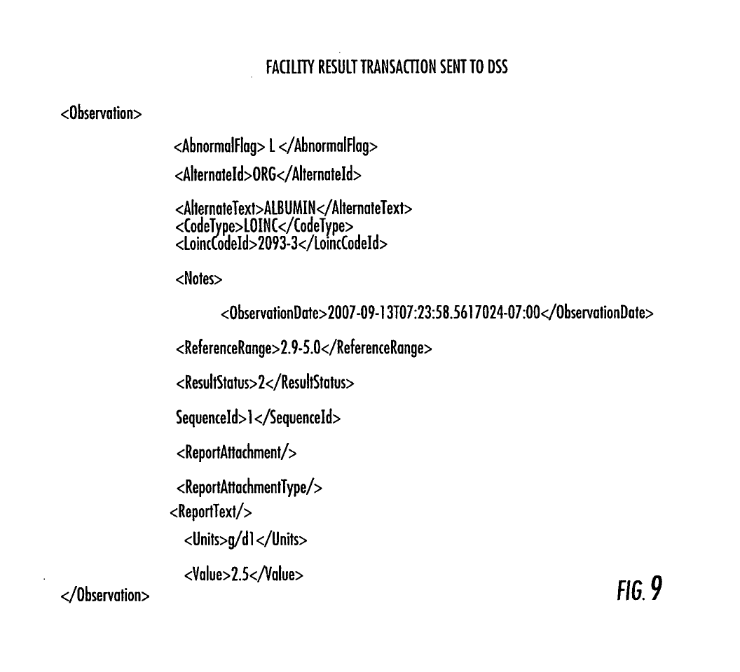

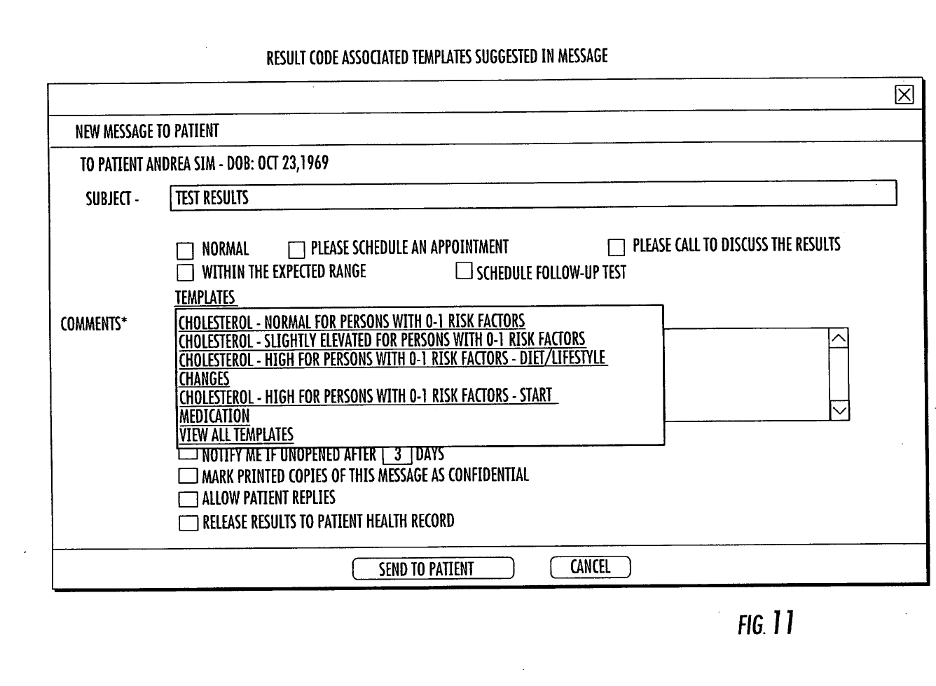

As indicated in FIG. 8 and Step 315, a healthcare facility generates a results transaction, such as the results from a cholesterol panel, and transmits the transaction to the DSS 100. The results transaction typically includes a procedure code and results information. Moreover, the results transaction can be in several formats including Health Level Seven (“HL7”) or Extensible Markup Language (“XML”). In other embodiments, the results transaction can be transmitted in a format that is converted into HL7 or XML. In these embodiments, the template module 70 can convert the data or receive the converted data from another module. The DSS 100 can transmit the results transaction data to the appropriate provider, as indicated in Step 320. The results transaction data can be viewed by the provider (Step 325), and the provider can initiate a message to the patient (Step 330). In one embodiment, after the provider initiates a message to the patient, the template module 70 maps the results transaction data, e.g., the LOINC code, to the corresponding result template(s). In this example, LOINC code 2093-3 maps to several potential result templates (shown in FIG. 11). Mapping the results transaction data can occur prior to, after, or simultaneously with the initiation of the message to the patient.

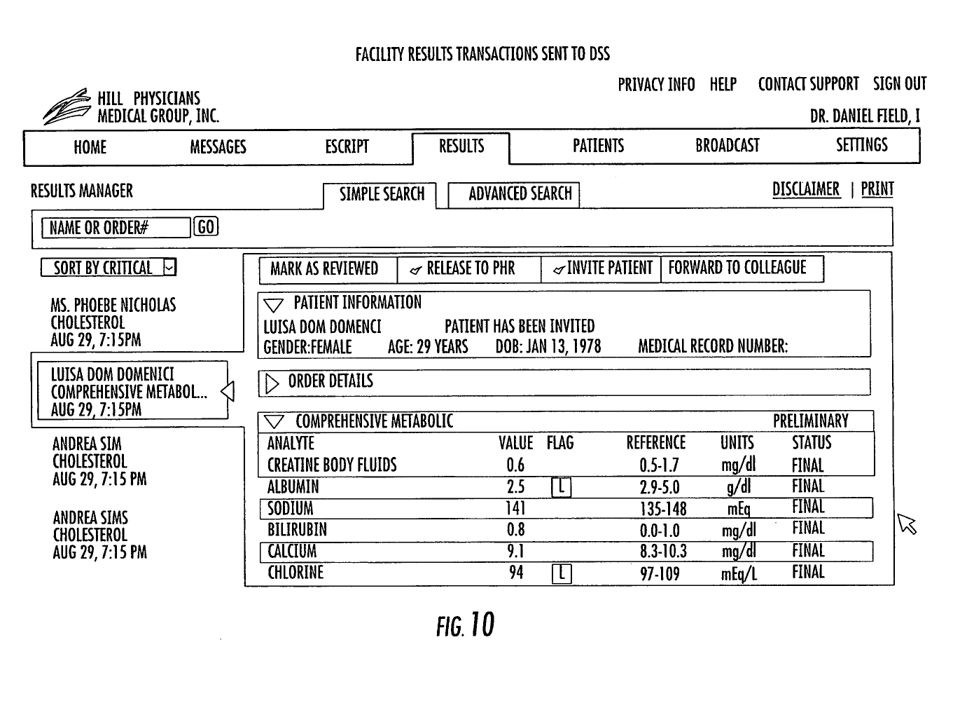

The result templates can be displayed, such as by name or otherwise in a listing or the like, to the provider as a suggestion of which template should be used. In this step, a single result template can be suggested by the template module 70 or several templates can be suggested (as seen in FIG. 11). This begins the creation of the message to the patient. As also seen in FIG. 11, the message can include additional reporting options, such as releasing the results to the patient health record other the patient's doctor. After reviewing the suggested result templates (Step 335), the provider can select the appropriate result template (Step 340), and the template module 70 can automatically populate the statement parts of the patient message. In this example, the template module 70 maps the laboratory results shown in FIG. 10 to the corresponding statement parts as shown in FIG. 12. For instance, the template module 70 maps the total cholesterol, triglycerides, low-density lipoprotein (“LDL”), and high-density lipoprotein (“HDL”) to their corresponding statement parts in the result template. In this embodiment, the provider is also provided with the option of excluding any of the suggested statement parts (Step 345). For example, in this embodiment, the provider could exclude the statement part recommending aerobic exercise or any other statement part if desired.

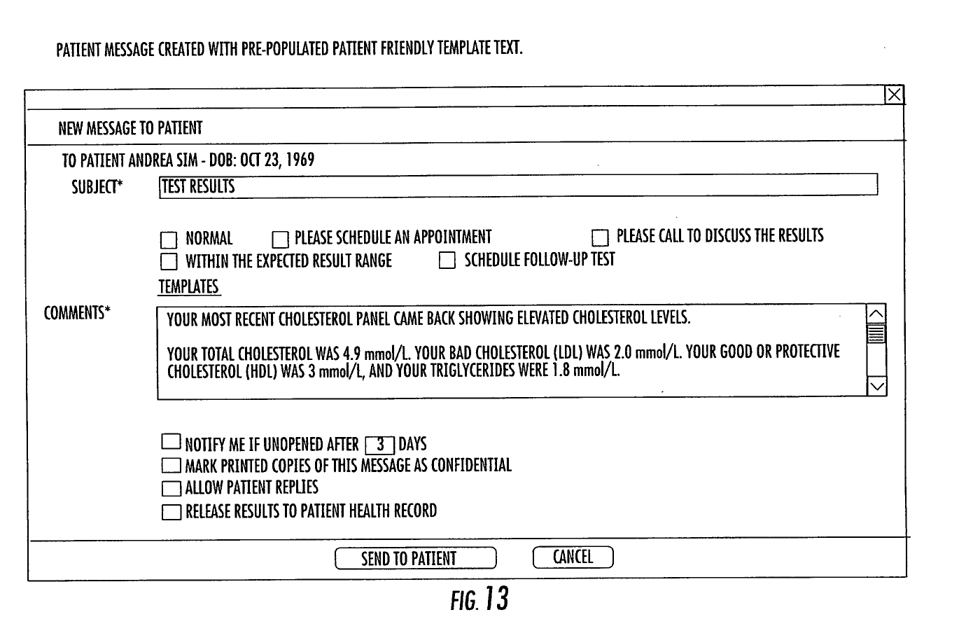

As shown in FIG. 13, after selecting the desired statement parts, the provider can transmit the message to the patient reporting the laboratory results of the cholesterol panel. Thus, the patient is provided with a patient-friendly message that is easy to understand. The transmitted message can be of any kind, including a text message, fax, or email. Similarly, the message can be printed out and mailed on a provider's letterhead, for example. Additionally, the message sent to the patient can be tracked and audited to ensure patient security and privacy. Still further, the message can be optionally included in the patient's record with the provider or sent to other providers treating the patient. And although this example is described for providing laboratory results, the template module 70 can be used to create any kind of message to any party.

### Workflow Module

In the following sections, exemplary embodiments are described with a pharmacist as a user performing an intervention (or workflow) that requires action by a patient's doctor (e.g., a third party). In the embodiments, the workflow module 60 is described in phases that may include one or more steps. The phases and steps do not necessarily need to be performed in a specific order, but are presented as such to aid in understanding the various embodiments of the present invention. It should also be recognized that the embodiments of the present invention are not limited to pharmacists and doctors or to the health care industry. In fact, the various embodiments can be useful in a variety of industries in which client/customer plans that require action items and/or follow up by various parties.

Generally, the workflow module 60 enables providers, e.g., doctors and pharmacists, to view patient records, document medical information, and perform patient interventions via the DSS 100. The term “intervention” is used generically to connote a workflow that is used to generate an actionable care plan for a patient. The various interventions (or workflows) can be sponsored by different parties, such as health care plan providers, hospitals, or any other party. For example, a health care plan provider can require prescription-specific interventions such that each time a particular medication is prescribed it triggers a specific intervention. In one embodiment, the workflow module 60 can then guide the pharmacist through a series of questions, submit action items to the patient's doctor (e.g., requesting a change in medication or dosage), and receive the doctor's response once the action items have been acted upon.

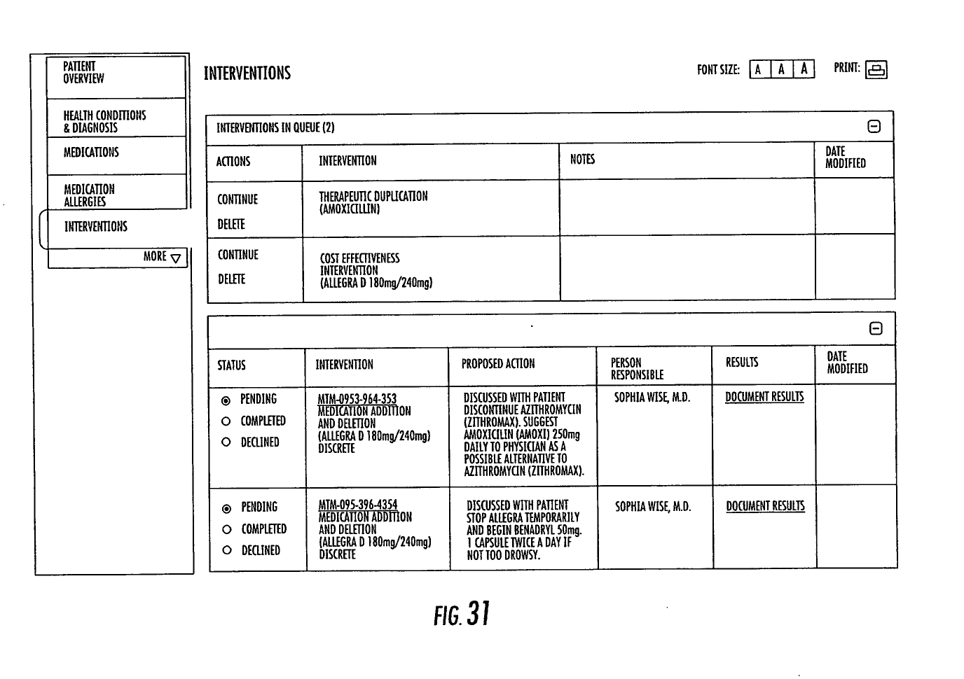

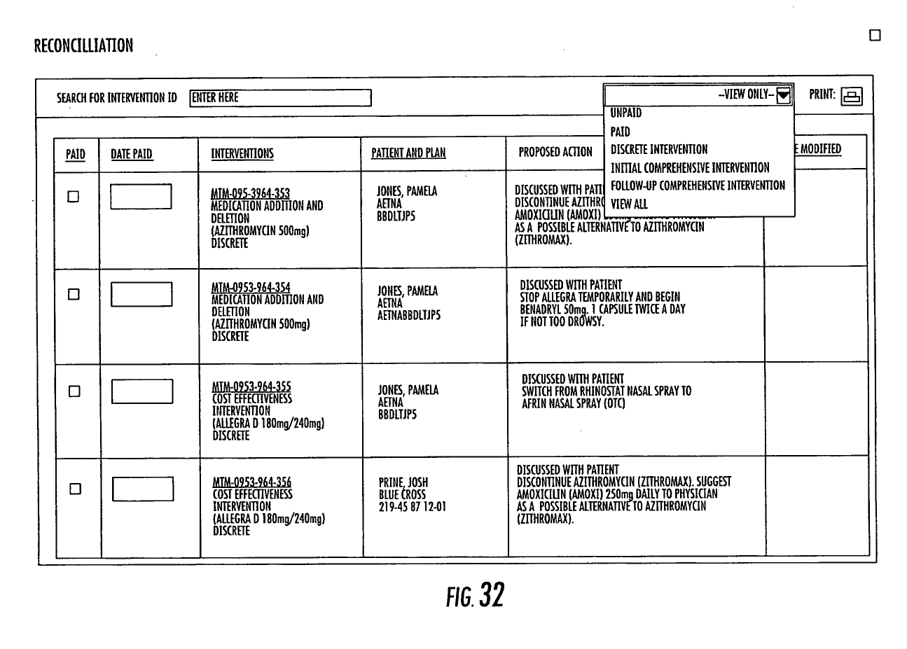

Thus, as indicated, the “care plan” typically includes medical information about the patient and action that needs to be taken for or on behalf of the patient. In one embodiment, the created care plan can be sent electronically to the patient's doctor for completion of the action items. In response, the doctor can communicate the action item results via the DSS 100 to the pharmacist who created the care plan. In one embodiment, the doctor's response may indicate that the action items were completed/approved, rejected/denied, or that more follow-up is necessary. As should be recognized, the responses to the action items may vary depending on the nature of the items. Additionally, the workflow module 60 can also provide the doctor (or other third party) with ability to view and modify each care plan received or automatically generate follow-up tasks, including viewing the status of previously communicated action items and documenting notes or results related to the action items (see FIGS. 31 and 32). The workflow module 60 can also provide billing functionality to the various parties. That is, it can bill the appropriate parties for the intervention or action items associated with each patient and/or task.

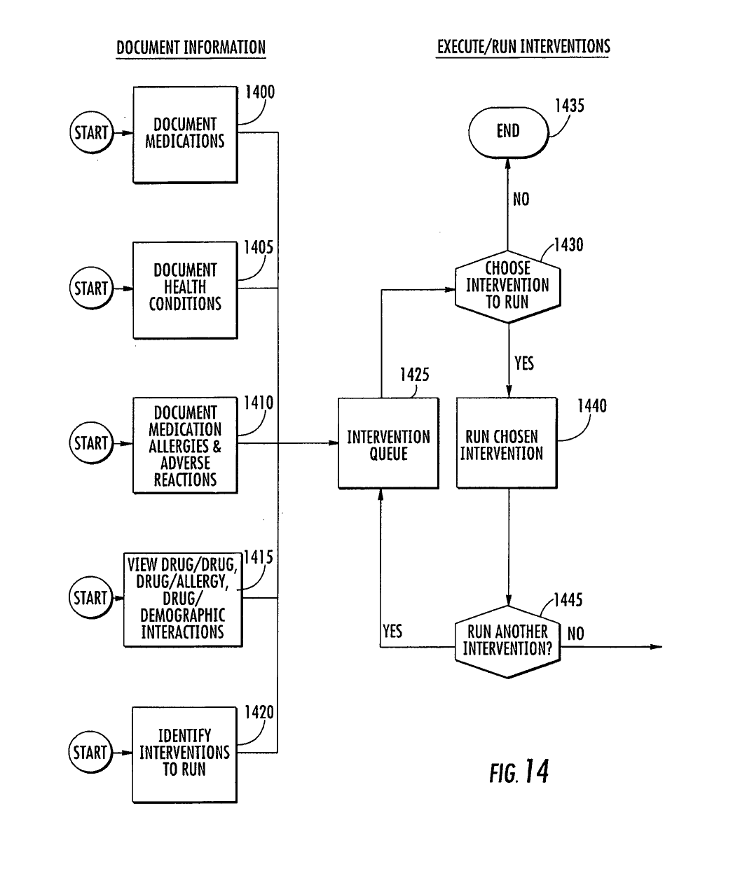

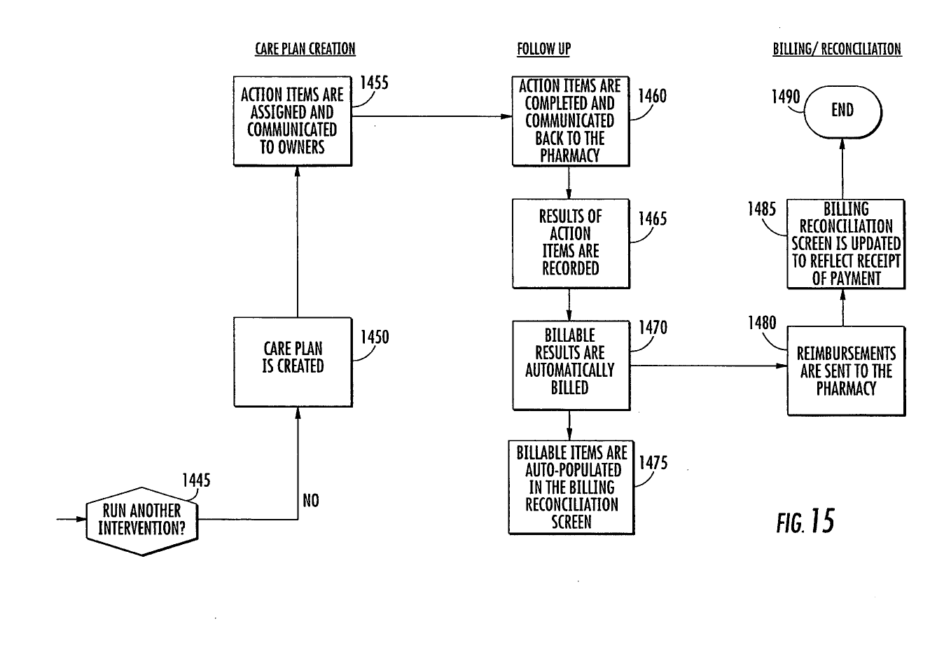

As mentioned, in one embodiment, the workflow module can have several phases, some of which are indicated in FIGS. 14-15: Identify Patients; Document Medical Information; Execute/Run Interventions; Care Plan Creation and Follow Up; and Billing and Reconciliation. These functions are discussed in greater detail below.

a. Identify Patients

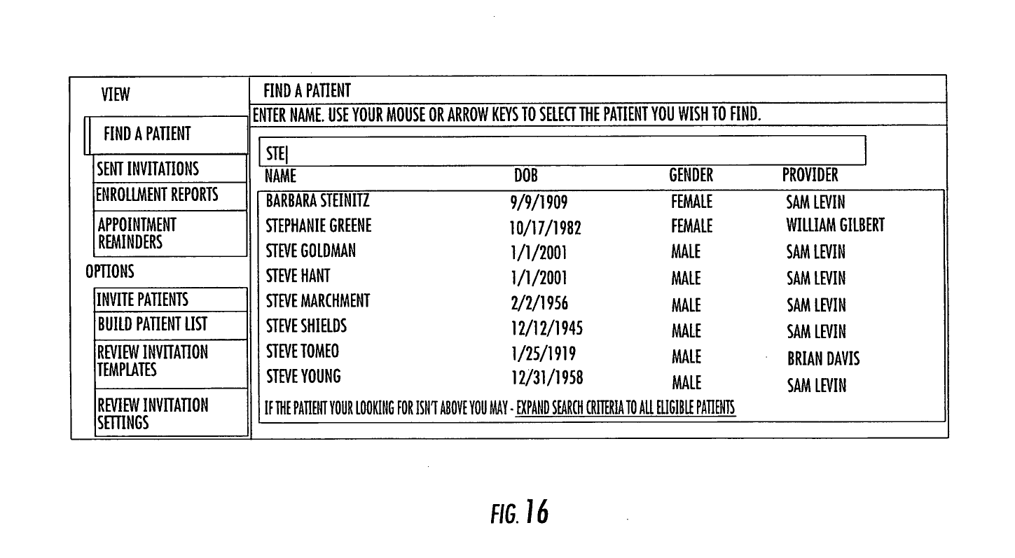

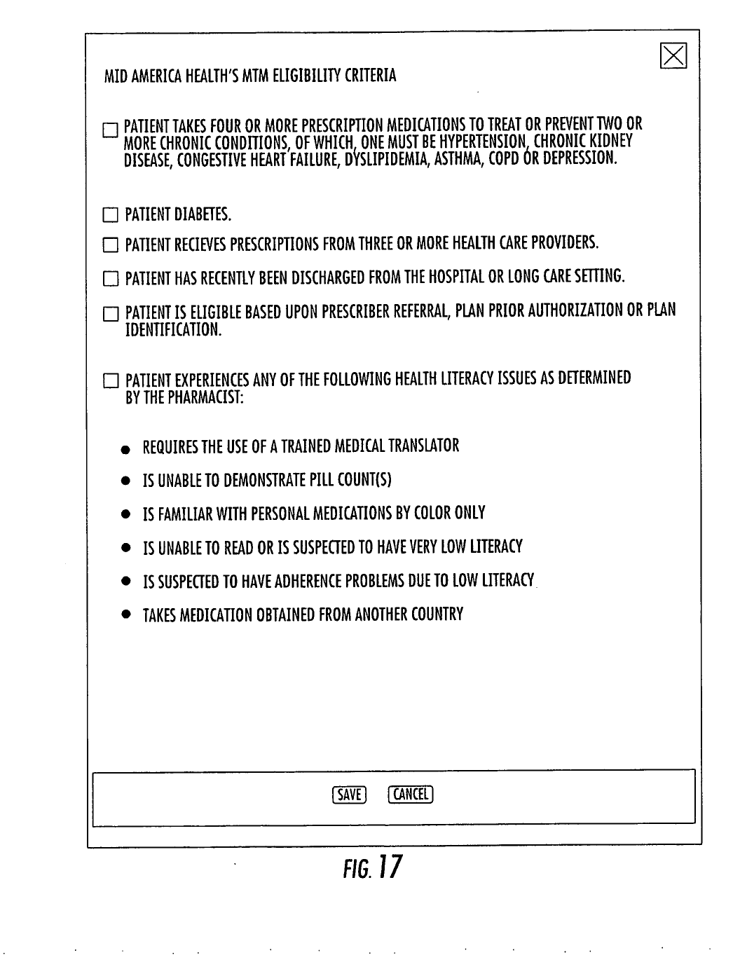

One of the first steps that can be performed by the pharmacist is to locate a specific patient(s). As seen in FIG. 16, the pharmacist can search for a patient by name or scroll through the list of patients. Similarly, as seen in FIG. 17, the pharmacist can query for patients satisfying specific eligibility criteria. The eligibility criteria are typically used to search for patients that may need a pre-defined intervention to be performed. As can be seen in FIG. 17, in this example, the pharmacist may want to search for patients who receive prescriptions from three or more health care providers and who are insured by Mid America Health. Such a query would help identify particular patients who may need a drug-to-drug intervention to be performed. Once a patient is identified, the pharmacist can retrieve the patient's record via the DSS 100.

b. Document Medical Information

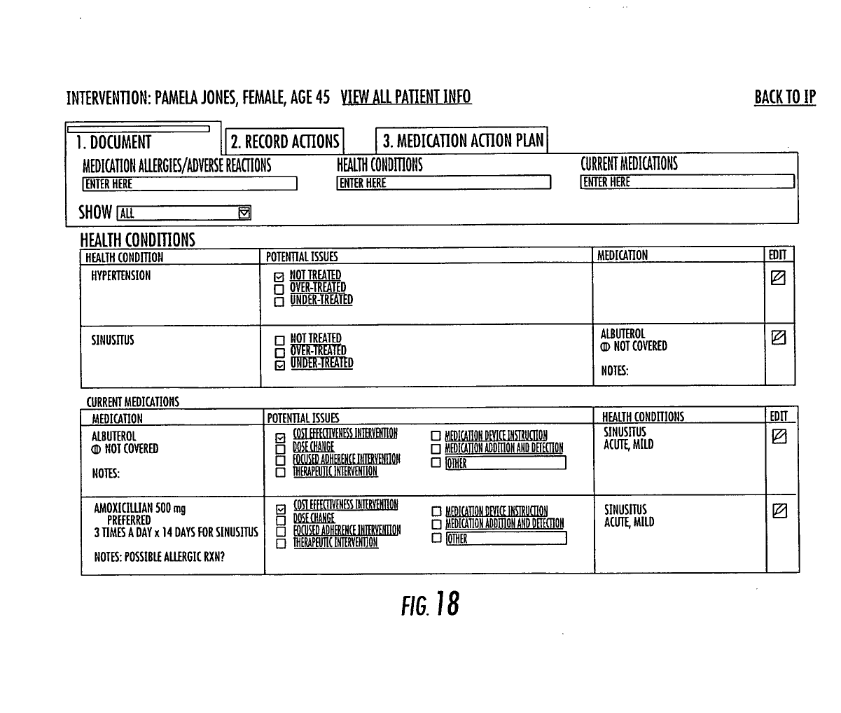

After retrieving the patient's record or other information, the pharmacist can document/record medical information relating to the patient (“Pamela Jones” in this example). To aid the pharmacist, the patient's record can be linked to the patient's actual medical record so that the pharmacist can retrieve any additional information that may be relevant to the intervention. As shown in FIG. 17 and by Steps 1400, 1405, 1410, 1415, and 1420, the pharmacist can document medical information such as health conditions, prescribed medications, allergies, adverse reactions to specific medications, drug-to-drug interactions, drug-to-allergy interactions, and/or drug-to-demographic information. In one embodiment, after documenting/recording the patient's medical information, the workflow module 60 provides specific interventions that can be executed based on the recorded medical information. In another embodiment, the workflow module 60 provides a standard list of the interventions that can be run for the patient. As seen in FIG. 18, the pharmacist can select from the displayed list. In this example, the pharmacist selects to execute the “Cost Effectiveness Intervention.” It should be noted that the pharmacist can select to execute more than one intervention. If more than one intervention is selected, the workflow module 60 maintains the interventions in an intervention queue as indicated in Step 1425 of FIG. 14. Moreover, the pharmacist (or other user) can select the order in which the interventions are to be executed.

c. Execute/Run Interventions

As can be seen in FIG. 18, there are various interventions that can be run, including cost effectiveness interventions, dose change interventions, focused adherence interventions, therapeutic duplication interventions, medication device instruction interventions, medication addition and/or deletion interventions, a prescription renewal request, and many others. As mentioned, the interventions can be sponsored by different parties, such as health care plan providers and hospitals, and be used to perform a variety of tasks. In one embodiment, the interventions (or workflows) provide the pharmacist (or other user) with specific prompts that guide her in resolving or creating action items for each identified issue.

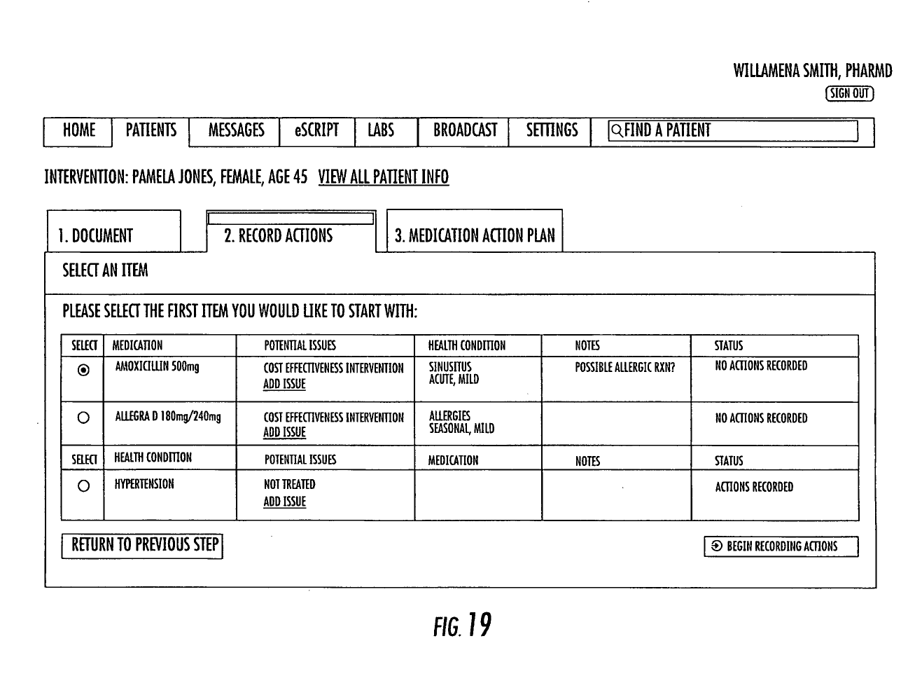

To access the various interventions, each intervention typically is associated with an intervention identification number (“intervention ID”). The intervention ID can contain a range of information including the amount billable by the providers for the intervention (the interventions may also be free) and/or the sponsoring health care plan provider. The intervention ID and the documented medical information can also be used to automatically retrieve information related to the intervention or patient. For example, in a cost effectiveness intervention, the workflow module 60 can automatically retrieve generic medications for the prescribed medication and the formulary status for the generic medication. After selecting the desired interventions (shown in FIG. 19), the workflow module 60 can provide the pharmacist with a display of the intervention queue. At this point, the pharmacist can select an intervention to execute (Step 1430) or access the intervention queue at a later time (Step 1435).

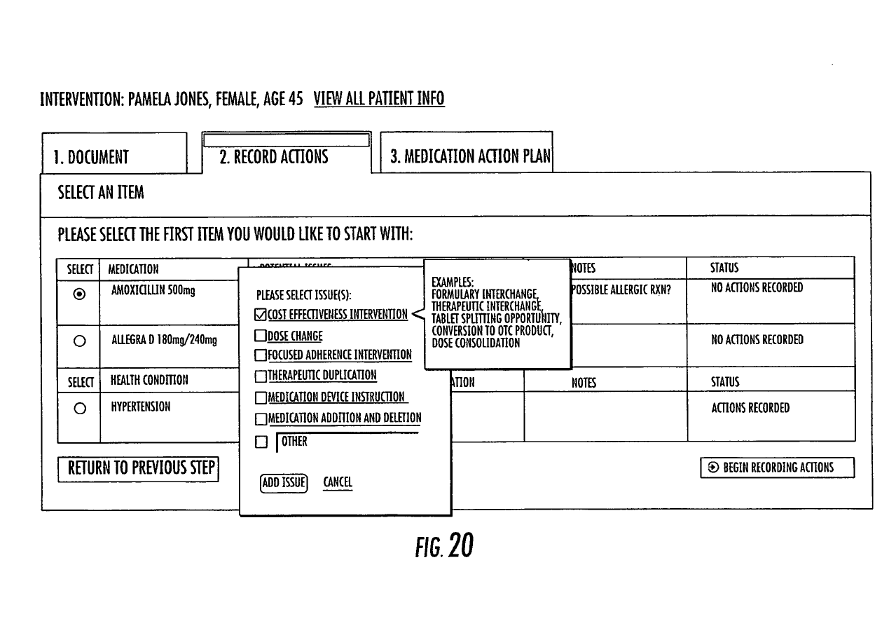

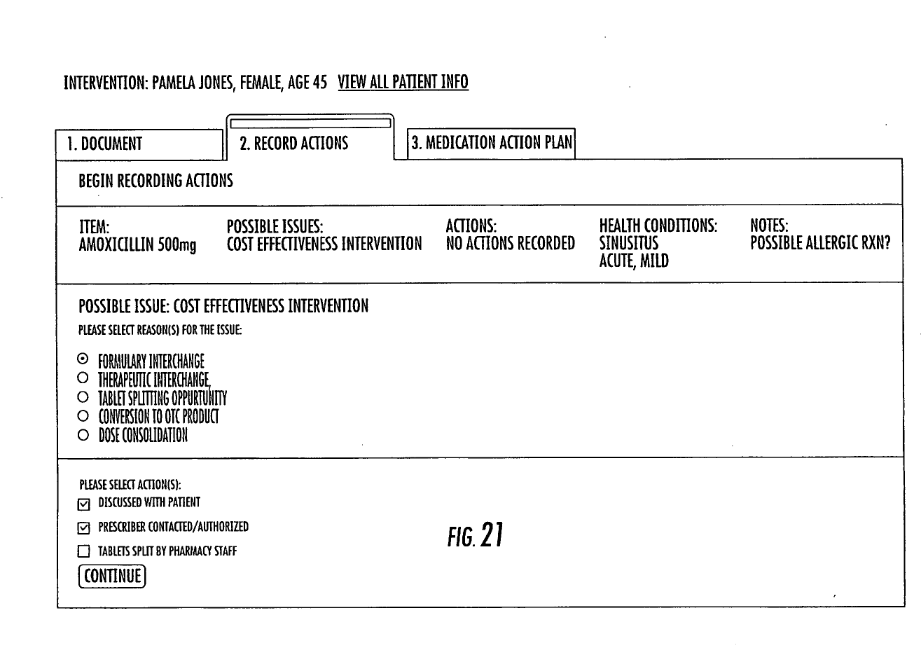

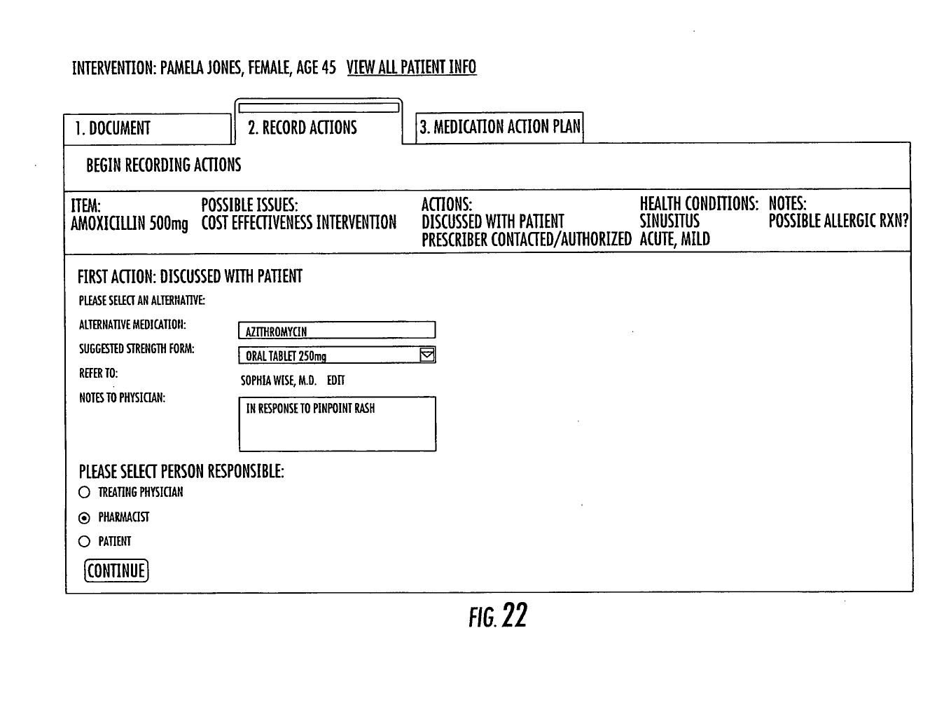

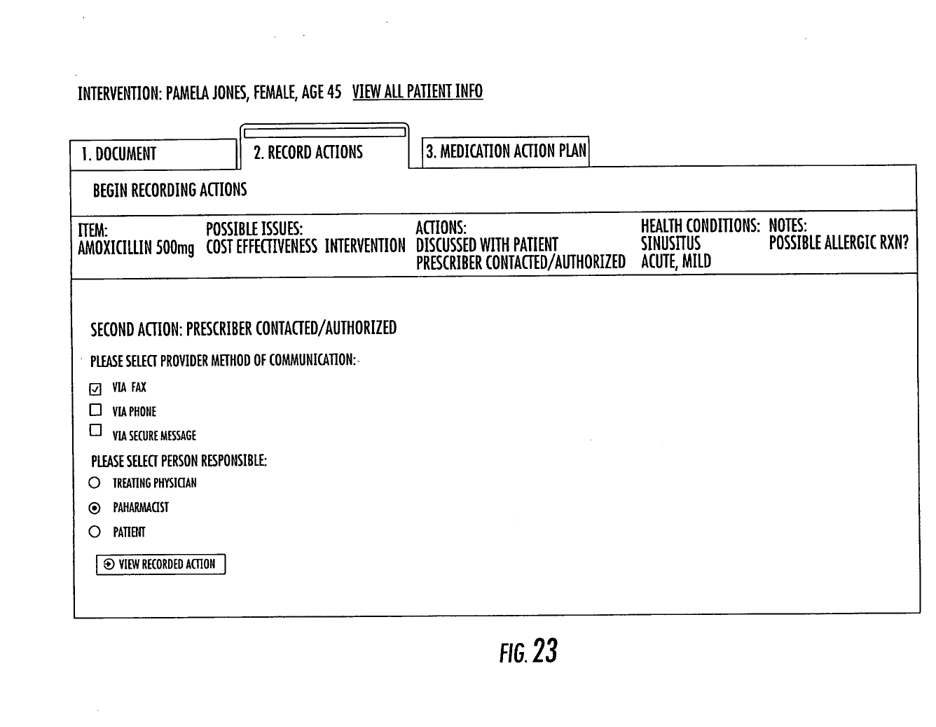

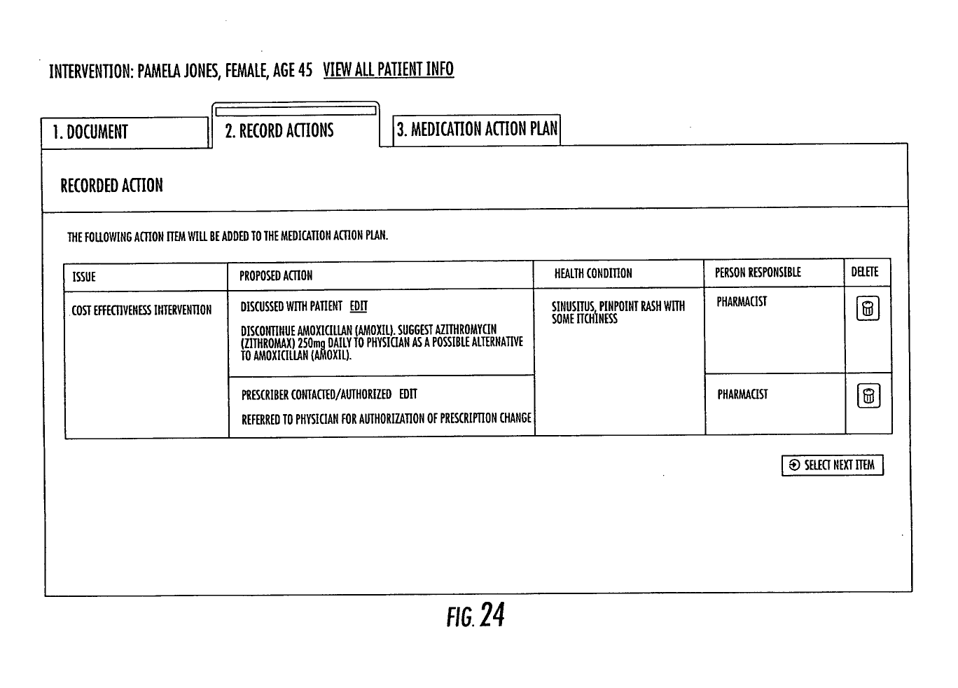

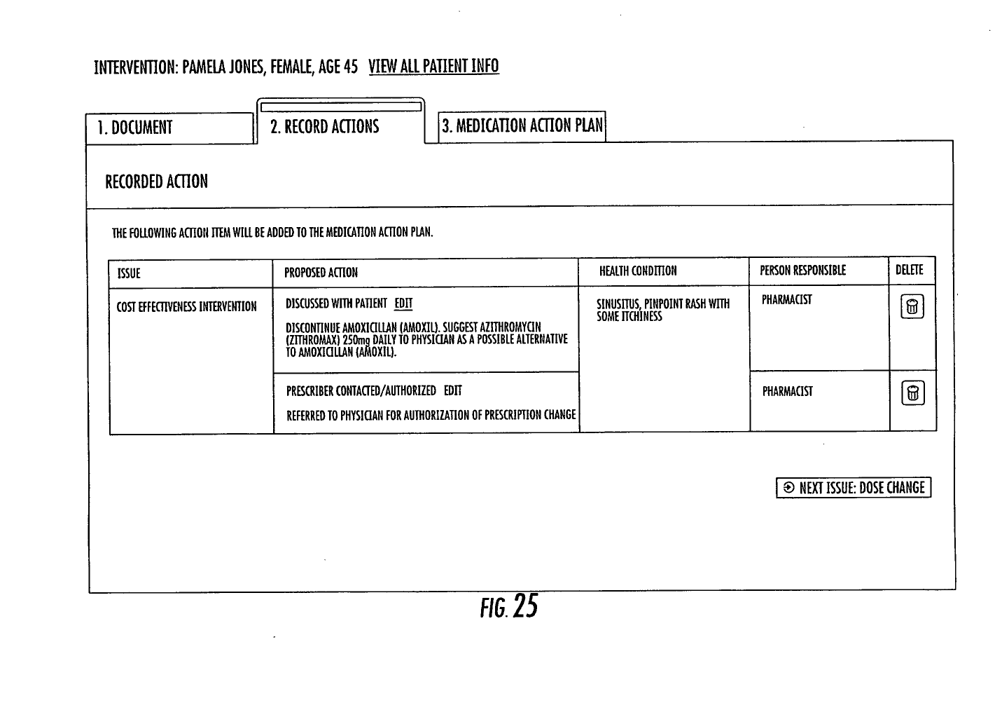

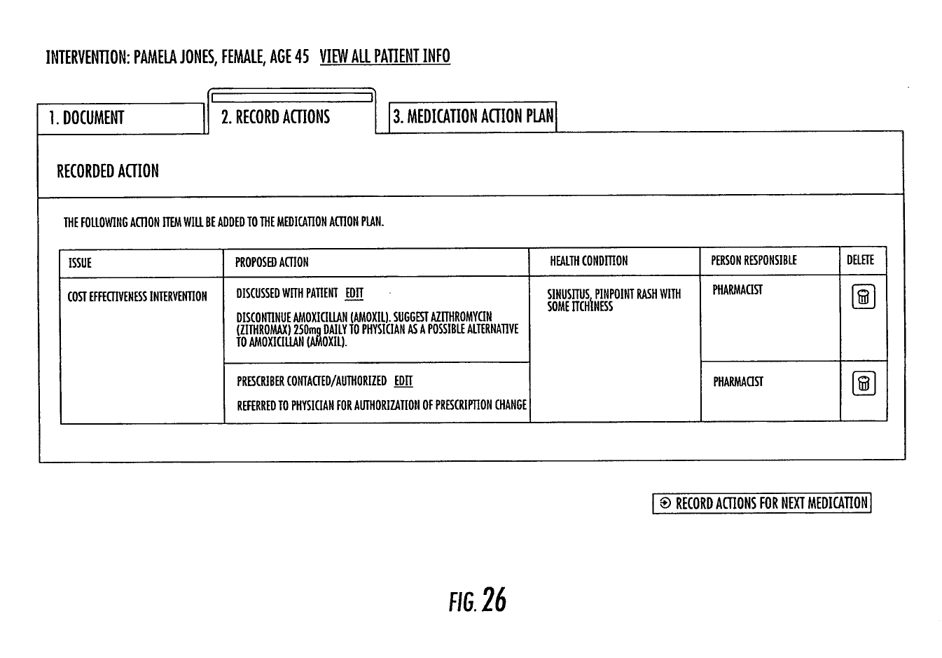

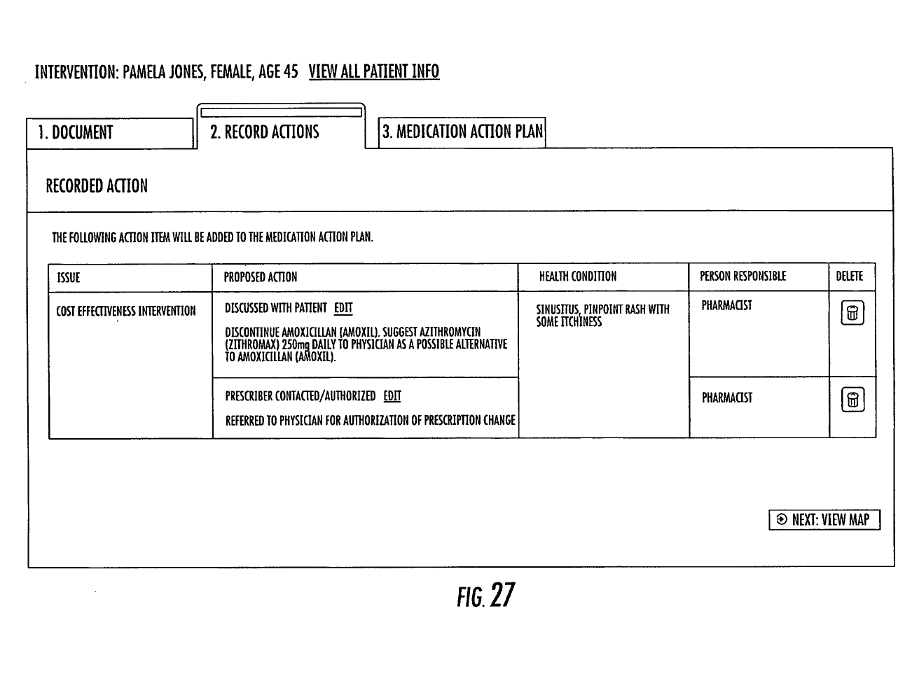

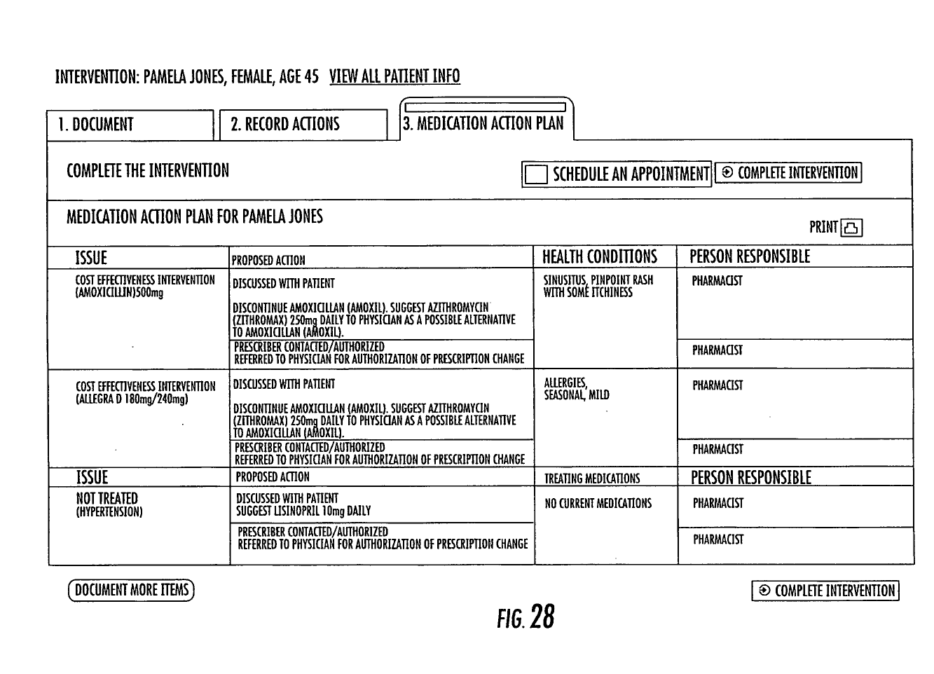

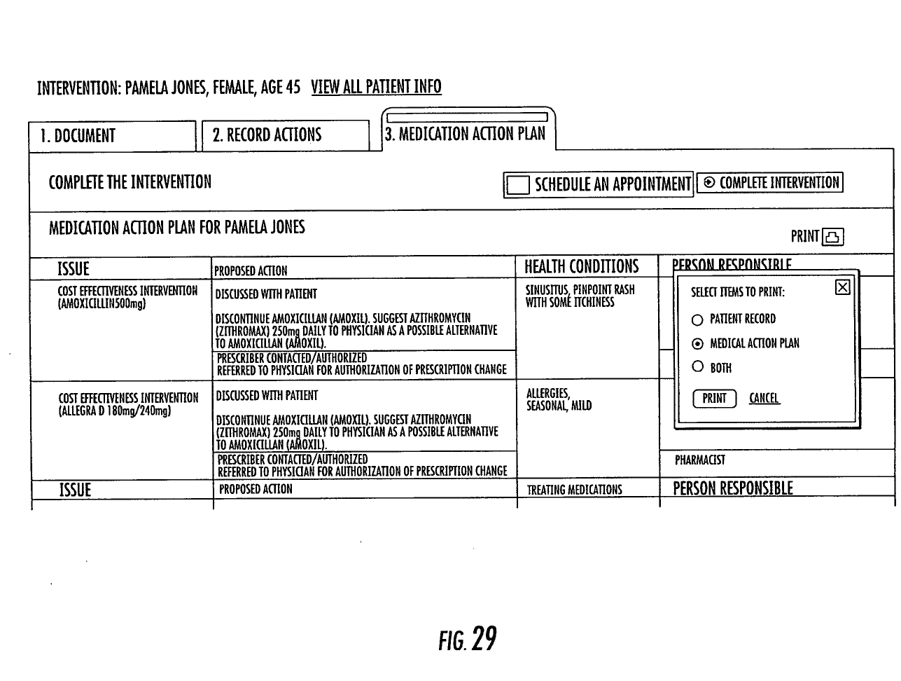

In either case, after selecting an intervention to execute and initiating the intervention (Step 1440), the pharmacist is guided through the intervention (e.g., a series of questions/steps). As shown in FIGS. 20 and 21, in this exemplary cost intervention, the pharmacist is prompted to indicate the reason for the intervention, e.g., formulary change, therapeutic interchange, tablet splitting opportunity, conversion to over-the-counter product, or dose consolidation. As shown in FIG. 22, the pharmacist can then recommend an alternative medication, its strength, and notes that can be transmitted to the patient's physician. This step creates the action item(s) for the physician to approve, deny, or otherwise act upon. In the provided example, the intervention also includes additional questions/steps with regard to the other medications. Thus, the intervention can be related to a single medication or multiple medications (each requiring a series of questions/steps for the pharmacist). After the steps are completed, the pharmacist can execute another intervention from the intervention queue (Step 1445) and/or create the care plan(s) and communicate it to the appropriate doctor(s). If the pharmacist executes another intervention from the queue, the steps will be similar to those discussed with respect to the cost effectiveness intervention. When the pharmacist is ready, she can view the final version of the proposed care plan before finalizing it and choose the method of communicating the care plan to the patient's physician, such as via fax, phone, or secure messaging (FIGS. 23-28). Additionally, as shown in FIG. 29, the pharmacist can print it out the information, e.g., the care plan, or electronically store it in association with the patient's record.

d. Care Plan Creation and Follow Up

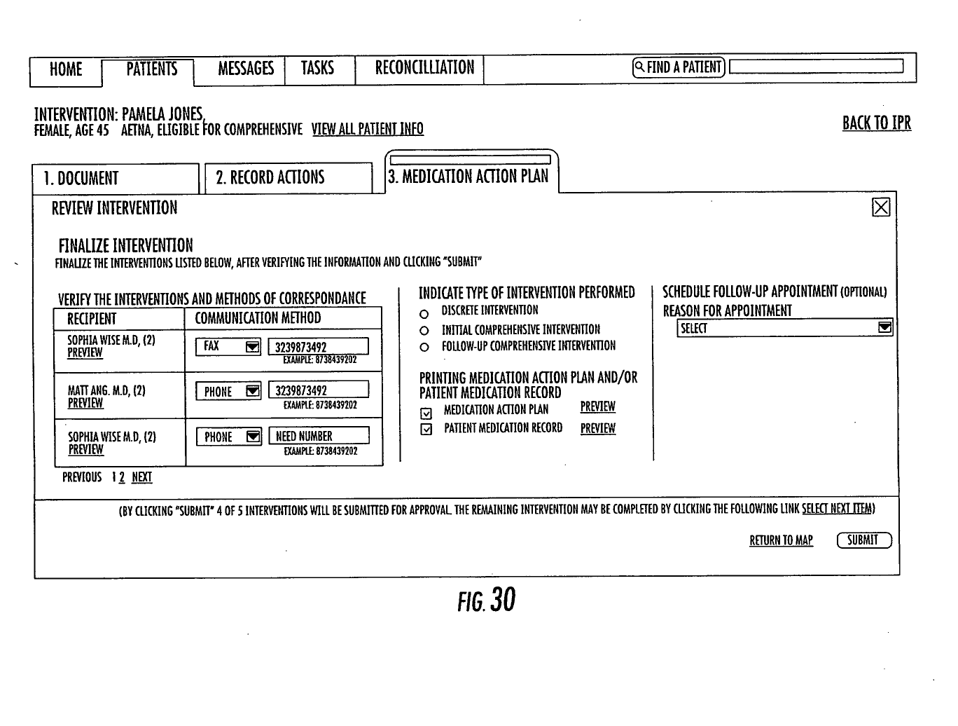

After confirming that the proposed care plan is accurate, the pharmacist can create the care plan and transmit it to the patient's physician (and Steps 1450 and 1455). The care plan can be communicated in a variety of ways, include fax, phone, or secure messaging (as shown FIG. 30). After the care plan is communicated to the doctor, the doctor or pharmacist can access the care plan and intervention via an interface to the DSS 100 and workflow module 60 to view the status. This can provide the parties with the most up-to-date status of the intervention and provide the ability to communicate additional information to each other. For instance, as shown in FIG. 31, the doctor can view each care plan's pending action items and the pending interventions. Thus, the doctor can approve or deny the pending requests at her convenience and transmit this information to the pharmacist. In one embodiment, to approve or deny the action items or requests, the doctor can select the appropriate radio button and submit the information to the workflow module 60. The workflow module 60 can then communicate the doctor's response to the pharmacist (Step 1460) and record it in the patient's record (Step 1465). Moreover, the doctor can alter the care plan and transmit the revised care plan to the pharmacist.

In addition to pending the action items for the doctor, the DSS 100 and workflow module 60 can be used to provide reminders to the doctor or pharmacist that action needs to be taken for a given intervention, care plan, and/or action item. In short, this provides the doctor with a user interface to view the pending interventions, care plans, and/or action items and to act upon them accordingly. Also, the doctor can view the completed interventions, care plans, and action items, which can then be used for billing purposes.

e. Billing and Reconciliation:

Each intervention ID can be associated with a billing code and/or a procedure code, such as an LOINC. This not only allows the providers to know how much they can bill for each intervention, care plan, or action item, it enables the workflow module 60 to automatically bill for the services once rendered (Step 1470). For example, when an action item is marked as complete, the workflow module 60 can notify the appropriate parties that the action item was completed and automatically submit the action item using the associated billing code and/or procedure code to a billing system (typically another module in the DSS 100).

Further, the DSS 100 can be used to provide the billing parties with a user interface through which they can track the status of each billed item. For example, as shown in FIG. 32, the provider can view/reconcile the payment status of all billed interventions for an entire practice (Steps 1475 and 1485). In one embodiment, each item can be updated to reflect that payment was received or is still outstanding. Similarly, the pharmacy can use the DSS 100 to track the status of its payments and reimbursements (Step 1480).

### Volume Processing Module

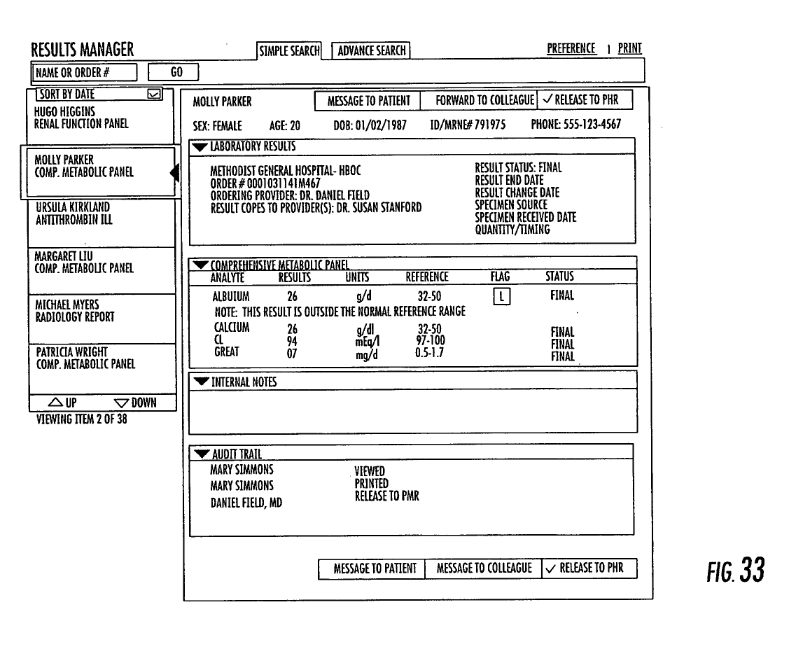

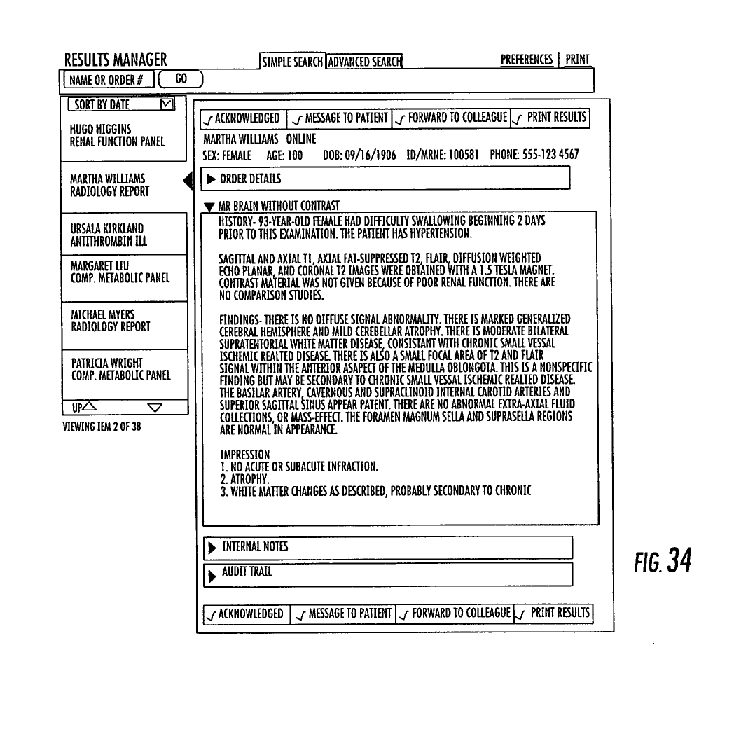

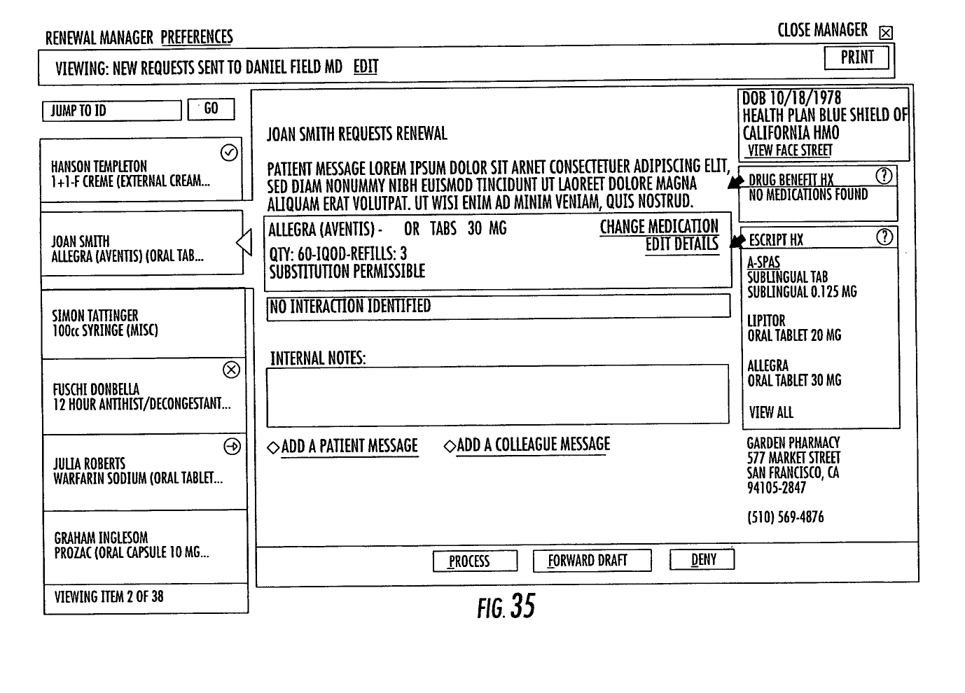

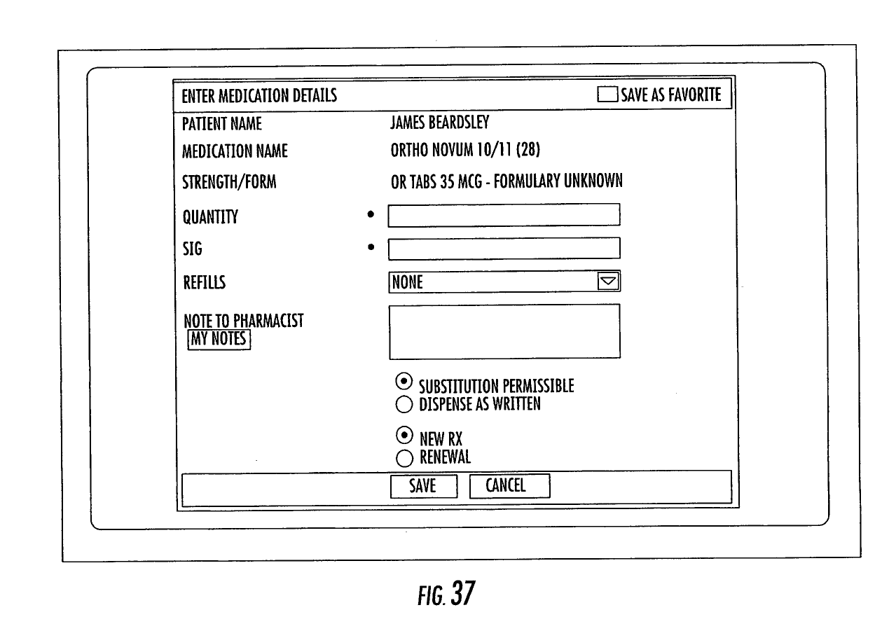

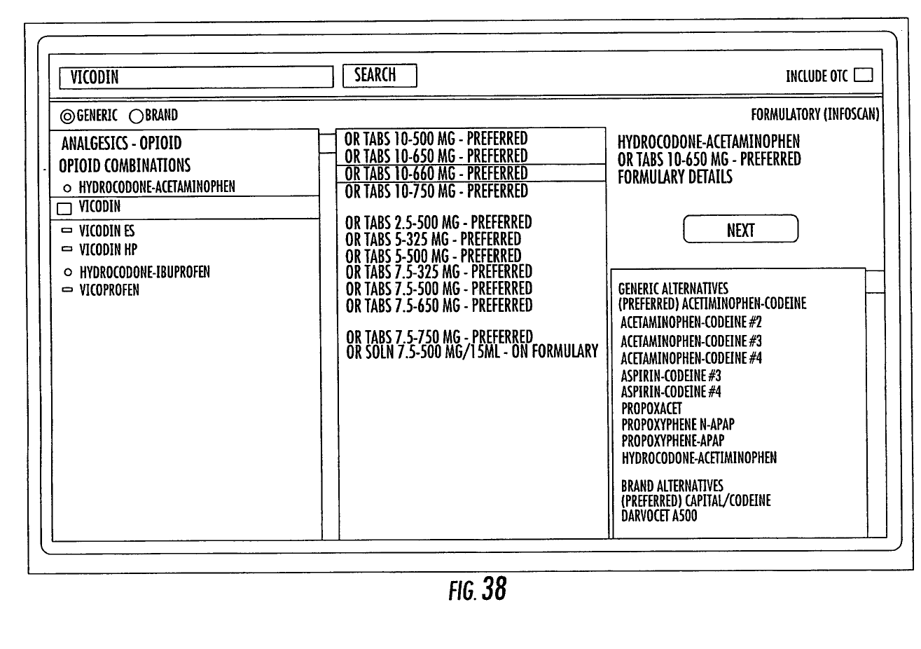

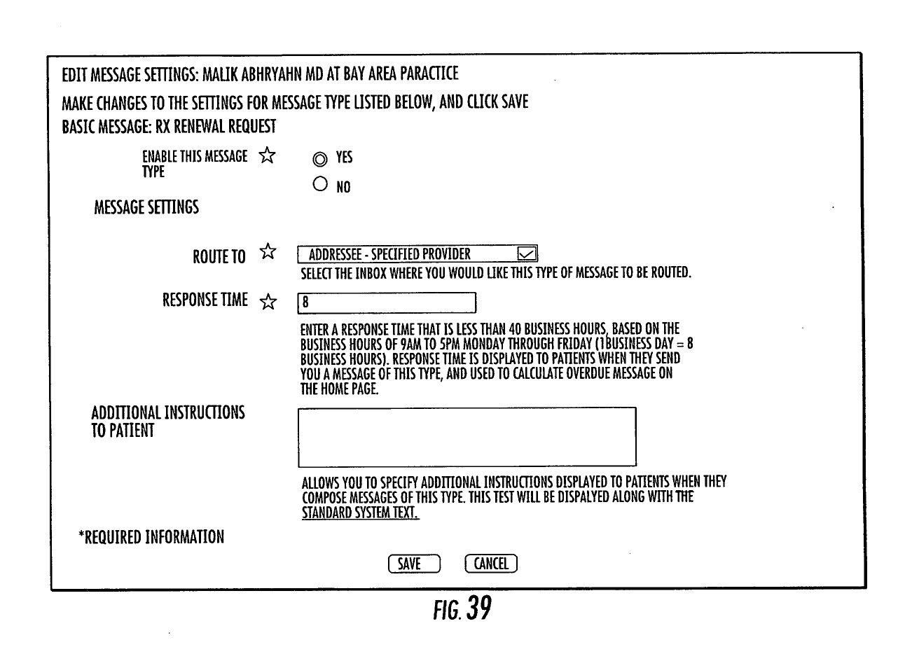

FIGS. 33-39 show exemplary input and output produced by one embodiment of a volume processing module 50. The volume processing module 50 receives tasks and formats them for easy processing. The formatting is particularly helpful in processing clinical tasks in high-volume, such as prescription renewal requests. However, the volume processing module 50 can be used to process any task. As seen in the figures, the user is provided with a user-friendly interface that shows several tasks to be completed. In one embodiment, the volume processing module 50 displays the tasks in a left-hand-tab design (as shown in FIGS. 33-35). This allows the user to view multiple tasks in an organized manner. However, the tasks can be display on any tool or in any other format, such as a floating toolbar.

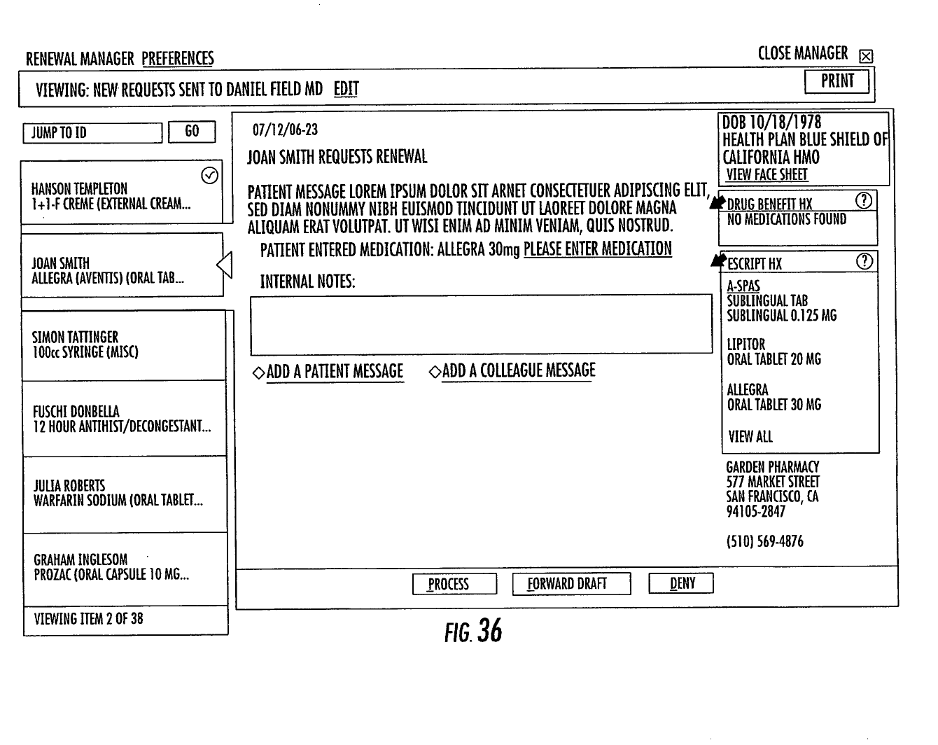

The volume processing module 50 also provides the user with the capability to scroll through or otherwise view the various tasks to choose one for processing. By selecting, scrolling over, or otherwise activating a task for processing, an expanded menu is provided for the task. The expanded menu can be used, for example, to resolve patient identities, create patient messages, create action items for doctors to perform, make prescription requests, and/or print and view the audit trail of the tasks. For instance, as shown in FIGS. 36-39, in a prescription renewal request, the doctor can change the prescription, view alternative generic medications, and/or send notes to the pharmacist. The volume processing module 50 can also provide clinical prompts to aid users in addressing clinical issues and provide interested parties with instructions and/or information related to the task. Through the DSS 100, the volume processing module 50 can also be used to communicate this information to the pharmacist, for example, via fax, email, or other forms of communication. The volume processing module 50 can also track the communications sent and/or received from other parties including patients and/or pharmacists. Once a task is processed, the user can use the menu to easily navigate to another task.

Thus, the volume processing module 50 allows the user to process multiple tasks with efficiency. It should also be noted that the volume processing module 50 can process renewal requests and other such tasks in the same way or a similar way as the workflow module 70 processes an intervention as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving results data, wherein the results data includes a procedure code and procedure results information;
mapping the procedure code from the results data to one or more result templates;
causing to display the one or more result templates;
mapping procedure results information to one or more statement parts of a respective result template; and
generating a message from the respective result template and the mapped procedure results information.

2. The method of claim 1 further comprising:
converting the results data from a first format to a second format.

3. The method of claim 1 further comprising:
transmitting the message to a party.

4. The method of claim 1 further comprising:
associating one or more procedure codes with one or more result templates.

5. The method of claim 1 further comprising:
selecting at least one statement part from the one or more statements parts of the respective result template to include in the message.

6. The method of claim 1 further comprising:
selecting at least one result template from the one or more result templates to use in creating the message.

7. The method of claim 1:
creating one or more result templates.

8. A system comprising:
a processor configured to:
receive results data, wherein the results data includes a procedure code and procedure results information;
map the procedure code from the results data to one or more result templates;
cause to display the one or more result templates;
map procedure results information to one or more statement parts of a respective result template; and
generate a message from the one or more selected result templates and the mapped procedure results information.

9. The system of claim 8, wherein the processor is further configured to:
convert the results data from a first format to a second format.

10. The system of claim 8, wherein the processor is further configured to:
transmit the message to a party.

11. The system of claim 8, wherein the processor is further configured to:
associate one or more procedure codes with one or more result templates.

12. The system of claim 8, wherein the processor is further configured to:
receive a selection of at least one statement part from the one or more statements parts of the respective result template to include in the message.

13. The system of claim 8, wherein the processor is further configured to:
receive a selection of at least one result template from the one or more result templates to use in creating the message.

14. The system of claim 8, wherein the processor is further configured to:
create one or more result templates.

15. A method comprising:
receiving customer information from a requesting party;
determining if the received information indicates that an intervention should be executed, wherein the intervention is associated with an intervention identifier;
executing the intervention;
receiving a notification from the requesting party that at least one task needs to be performed by at least one third party; and
transmitting the at least one task to the at least one third party.

16. The method of claim 15 further comprising:
notifying the at least one third party that the at least one task needs to be completed.

17. The method of claim 15 further comprising:
receiving notification that the at least one third party has approved or denied the least one task; and
in response to receiving notification that the at least one task has been approved or denied, notifying the requesting party.

18. The method of claim 17, further comprising:
automatically billing an entity in response to receiving notification that the at least one task was approved by the at least one third party.

19. The method of claim 15 further comprising:
generating periodic notifications to the at least one third party that the at least one task needs to be completed.

20. The method of claim 15, wherein the requesting party is a pharmacist.

21. The method of claim 15, wherein the at least one task is a prescription renewal request.

22. A system comprising:
a processor configured to:
receive customer information from a requesting party;
determine if the received information indicates that an intervention should be executed, wherein the intervention is associated with an intervention identifier;
execute the intervention;
receive a notification from the requesting party that at least one task needs to be performed by at least one third party; and
transmit the at least one task to the at least one third party.

23. The system of claim 22, wherein the processor is further configured to:
notify the at least one third party that the at least one task needs to be completed.

24. The system of claim 22, wherein the processor is further configured to:
receive notification that the at least one third party has approved or denied the at least one task; and
in response to receiving notification that the at least one task has been approved or denied, notify the requesting party.

25. The system of claim 24, wherein the processor is further configured to:
automatically bill an entity in response to receiving notification that the at least one task was approved by the at least one third party.

26. The system of claim 22, wherein the processor is further configured to:
generate periodic notifications to the third party that the at least one task needs to be completed.

27. The system of claim 22, wherein the requesting party is a pharmacist.

28. The system of claim 22, wherein the at least one task is a prescription renewal request.
